(19) United States
(12) Patent Application Publication
(10) Pub. No.: US 2002/0103969 A1
(43) Pub. Date: Aug. 1, 2002

(54) System and method for storing data

(76) Inventors: Hiroshi Koizumi, Tokyo (JP); Iwao Taji, Tokyo (JP); Tokuhiro Tsukiyama, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/944,940

(22) Filed: Aug. 31, 2001

(30) Foreign Application Priority Data
Dec. 12, 2000 (JP) 2000-383118

(51) Int. Cl. G06F 12/00

(52) U.S. Cl. 711/114; 711/170; 711/165

(57) ABSTRACT

This invention provides a method for operating a data storage system in which the performance of the data storage system is maintained at or above a specified level during use of the data storage system. The data storage system is provided with a performance monitor for monitoring operational status of the data storage system and for receiving input data to define the required data storage system performance. The system sets performance requirement parameters for various elements such like device busy rate, data transfer speed or other parameters that define storage performance. As the performance monitor monitors actual storage performance variables, if it detects a drop in the storage performance in a specific logical device or the entire data storage system, data is moved within the storage system so that the load is distributed appropriately to bring actual performance in line with the performance specification.

### BACKGROUND OF THE INVENTION

1. Field of the Invention

The present invention relates to a data storage system for storing data and a method for using a data storage system.

2. Description of the Prior Art

With the current advances in information technology in a wide range of industrial fields, there is a need to provide electronic management of data using servers and data storage systems even in fields where electronic data management has never been implemented. Even in fields where there used to be electronic data management using data storage systems, the amount of data is increasing significantly. As the amount of data increases, the storage capacity required increases also.

In such circumstances, it is not easy for data managers to newly introduce new servers or data storage systems by their own, or increase storage capacities at the right moment, to prevent crucial damages. And this has become too heavy a burden for them nowadays. To solve such a problem, a business of undertaking out-sourcing of data storage, such like lending servers or storages, has been growing recently. (One of such kind, for example, is called a data center business.)

An example of this type of out-sourcing business is disclosed in Japanese Patent publication number 2000-501528 (which corresponds to U.S. Pat. No. 6,012,032), in which storage capacity is lent and the charge for data storage is collected. According to the invention, data storage devices are characterized as high-speed, medium-speed, and low-speed devices in proportion to the access speeds of the devices. The accounting method for storage services according to this prior art involves requiring higher price per unit storage capacity for data recording devices with higher access speeds, i.e., charge for data storage is determined based on the type of data recording device being used in addition to the storage capacity being used. To collect the charge for data storage, information related to data elements are output from the data storage system, each of the charge for high-speed storage devices, medium-speed storage devices, and low-speed storage devices are calculated respectively, and summed to collect the overall charge, periodically.

### SUMMARY OF THE INVENTION

### Means for Solving the Problems

According to this prior art, the data storage devices are assigned and are fixed to each client according the contract. Once a data storage device is assigned, the data remains in the device.

However, while using this data storage system of the prior art, a sudden or a periodic increase of traffic might occur, and will cause degradation on system performance. Such degradation on system performance will occur, regardless of the capacity of the storage device. For example, even if there is enough free space, data access maybe significantly delayed if there is too much access toward specific data.

The object of the present invention is to provide a method for operating a data storage system, in which the performance of the data storage system is kept at a fixed level during use of the data storage system.

Another object of the present invention is to provide an input means, which is used to set required data storage system performance.

### Means for Solving the Problems

In order to solve the problems described above, a service level guarantee contract is used for each client to guarantee a fixed service level related to storage performance. In the present invention, the data storage system is provided with a performance monitoring part for monitoring operation status of the data storage system and data migrating means.

The performance monitoring part includes: a part for setting performance requirement parameters for various elements such like device busy rate, data transfer speed and so on that defines storage performance. Performance requirement parameter represents a desired storage performance. Such parameter can be, for example, a threshold, a function, and so on.

The performance monitoring part also includes; a monitoring part for monitoring actual storage performance variables that change according to the operation status of the data storage system. If the monitoring of the parameters indicates a drop in the storage performance in a specific logical device or the entire data storage system, data migrating means migrates data so that load is distributed.

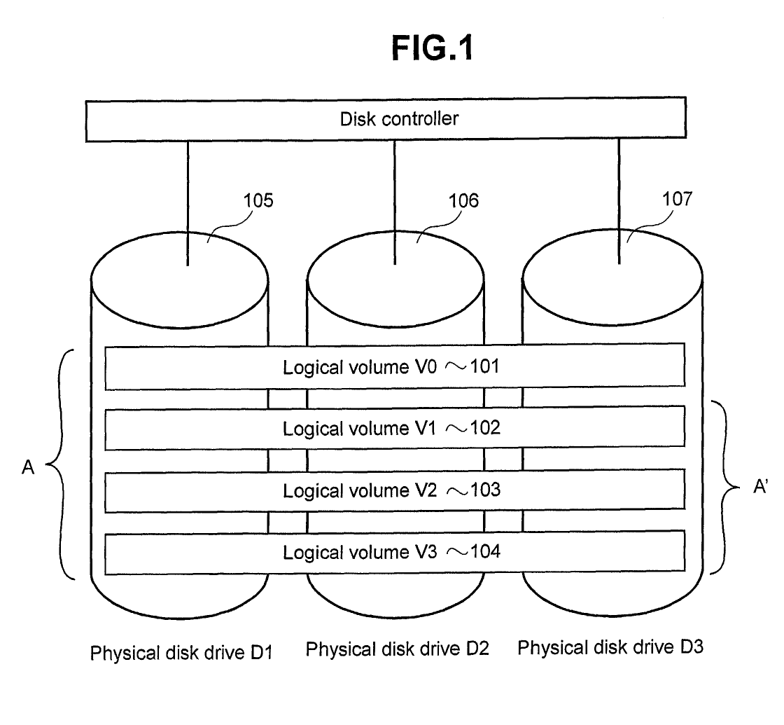

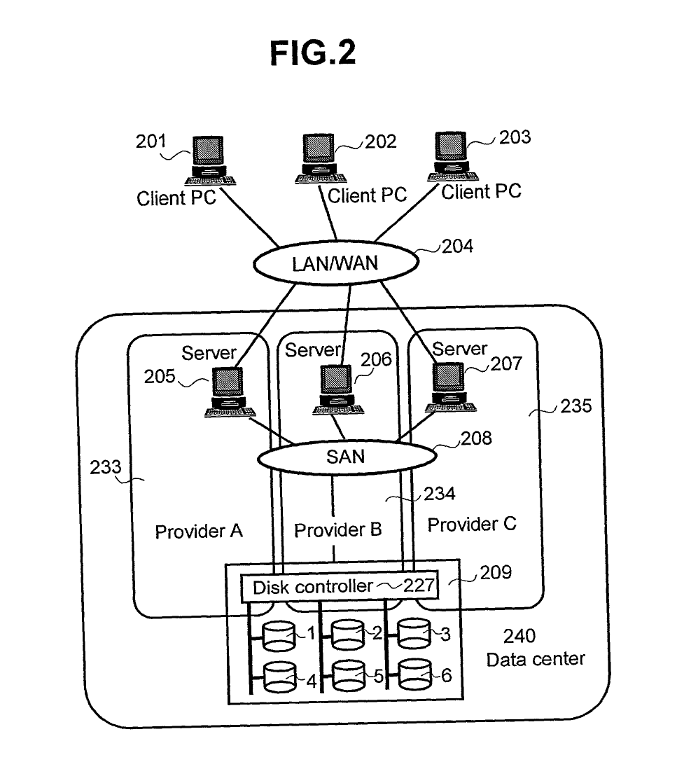

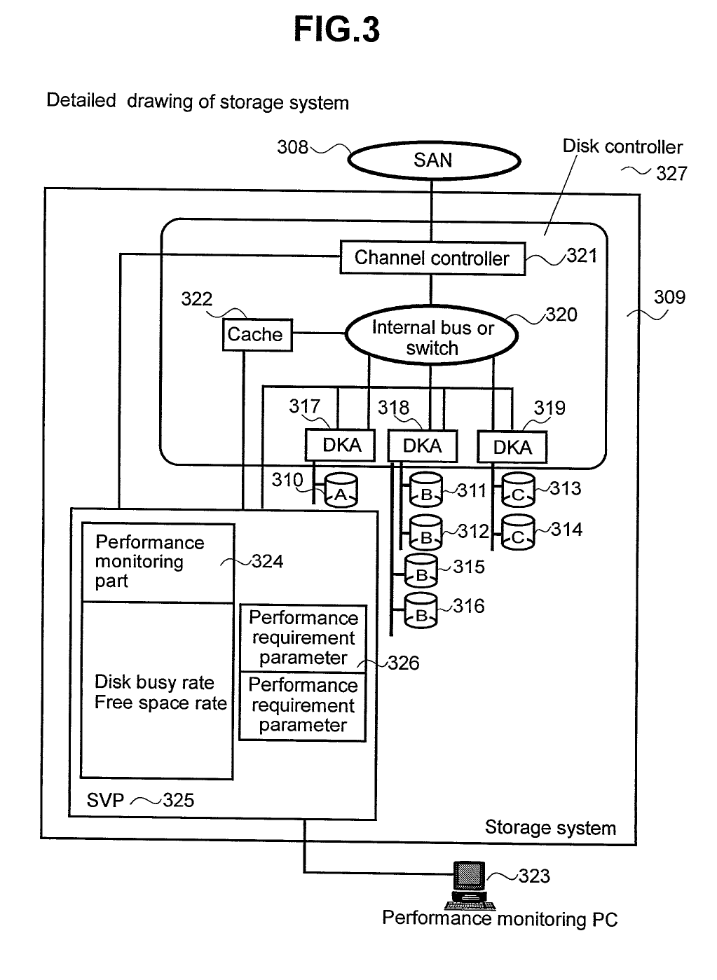

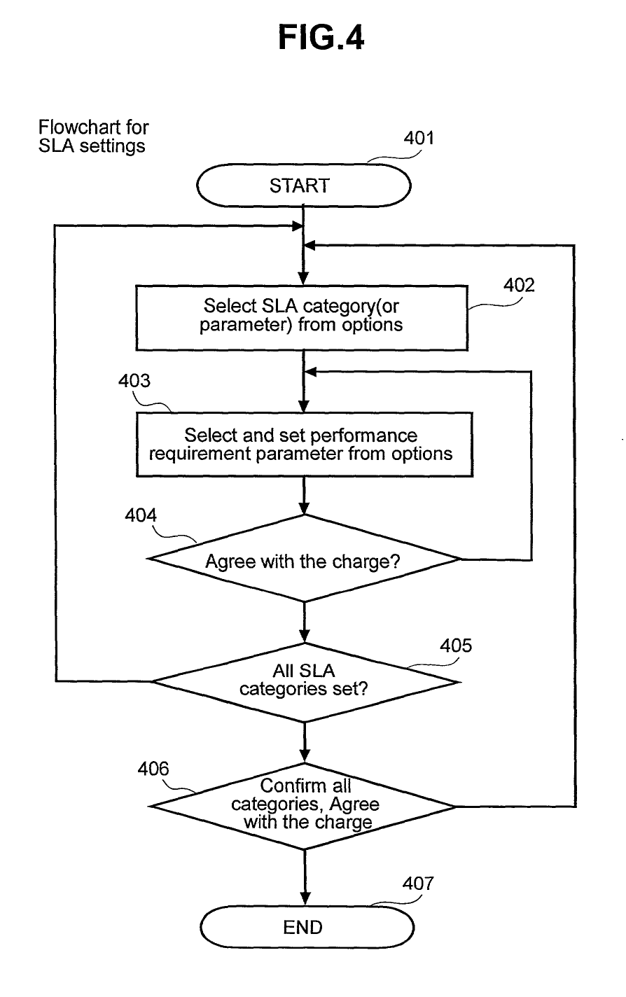

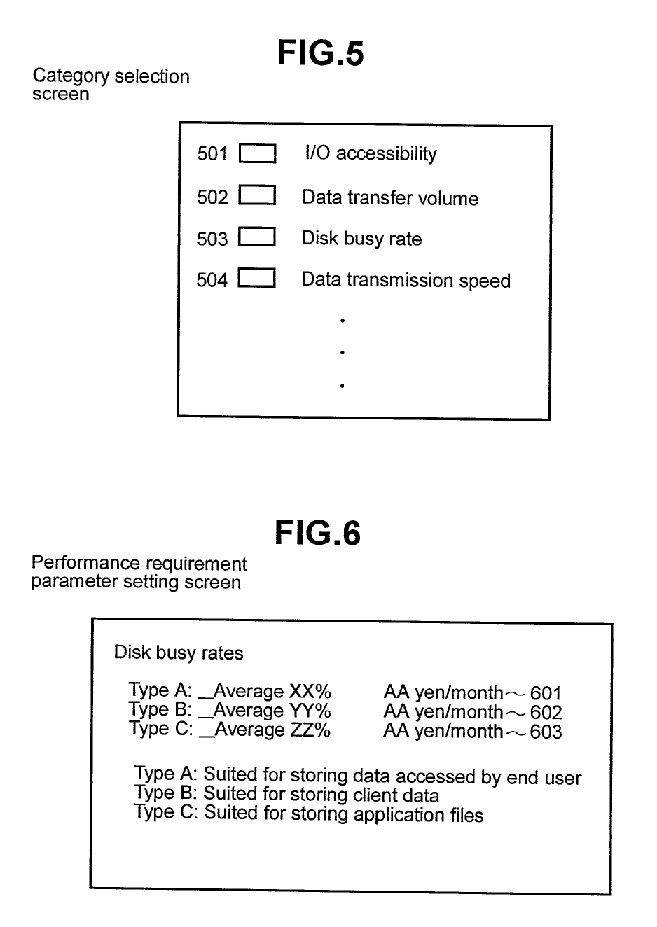

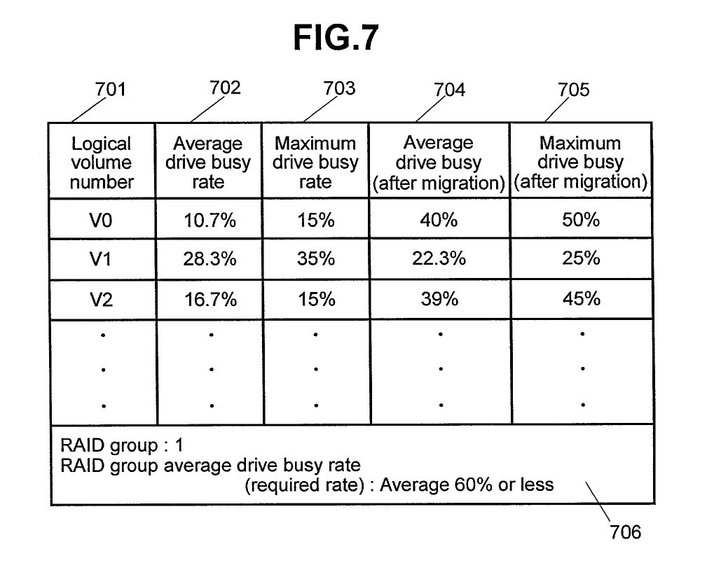

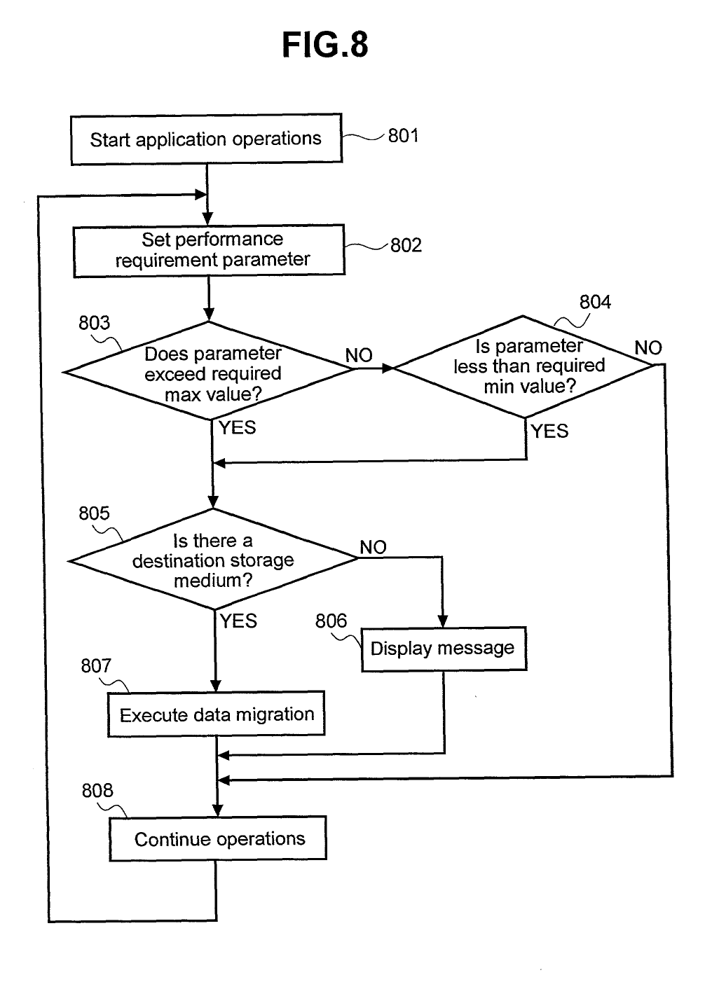

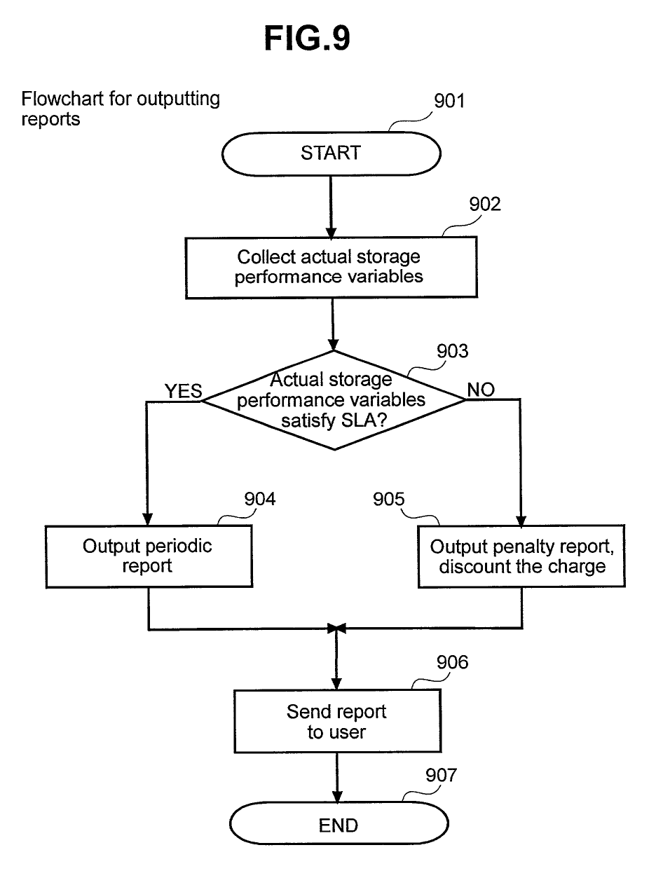

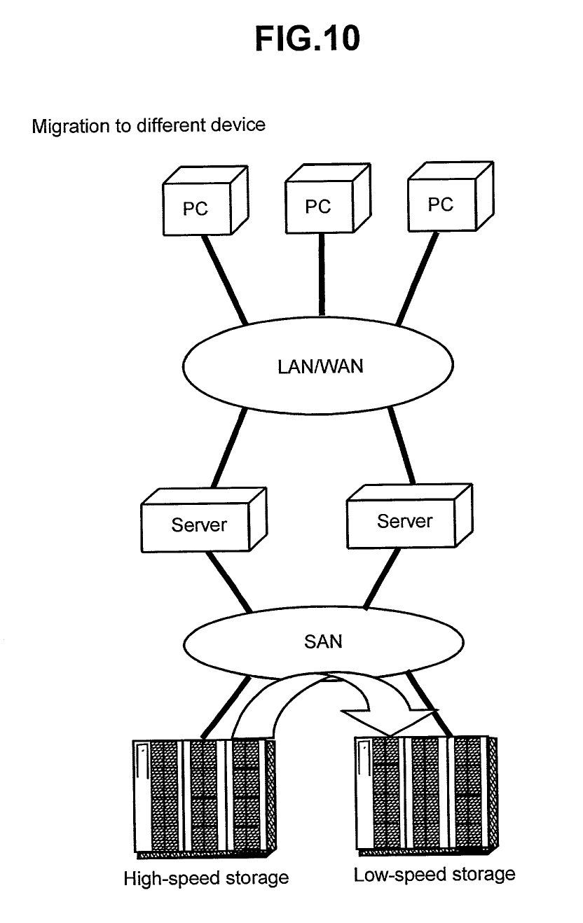

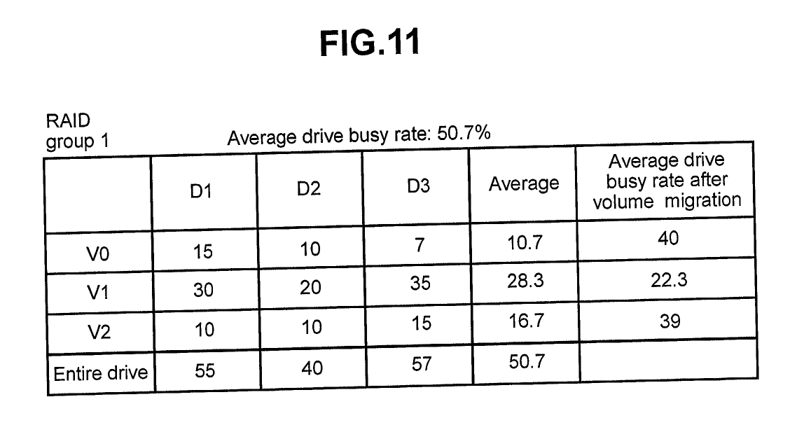

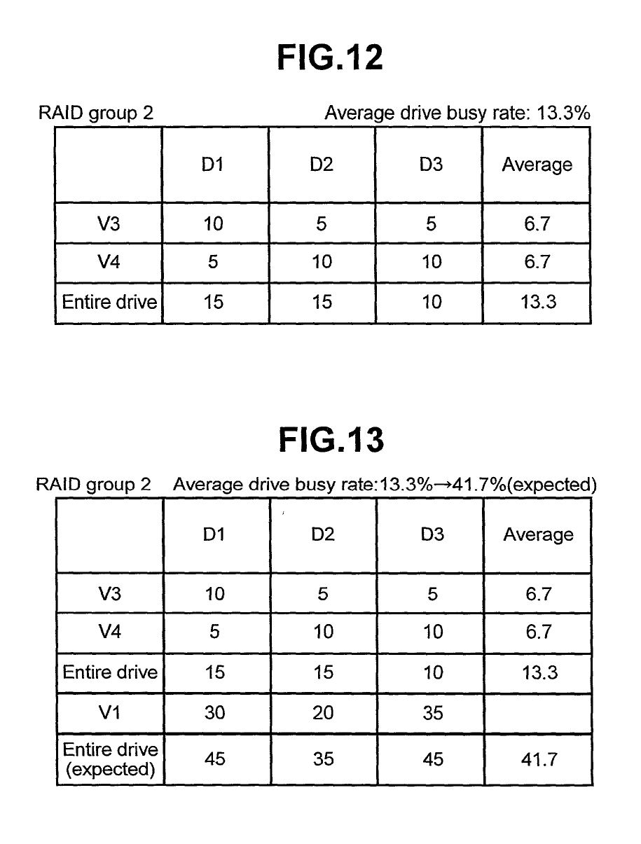

### BRIEF DESCRIPTION OF THE DRAWINGS

[FIG. 1] A schematic drawing of the RAID group.

[FIG. 2] A schematic drawing illustrating the relationship between data center, providers, and client PCs (end-user terminals).

[FIG. 3] A detailed drawing of a data storage system provided with a performance monitoring part.

[FIG. 4] A flowchart of the operations used to set a service level agreement (SLA).

[FIG. 5] An SLA category selection screen serving as part of a user interface for setting an SLA

[FIG. 6] A performance requirement parameter setting screen serving as part of a user interface for setting an SLA.

[FIG. 7] An example of a disk busy rate monitoring screen.

[FIG. 8] A flowchart of the operations used to migrate data.

[FIG. 9] A flowchart of the operations used to create a data storage system operating status report.

[FIG. 10] A schematic drawing of a data migration toward another device, outside the data storage system.

[FIG. 11] A sample performance monitoring screen.

[FIG. 12] An example of a performance monitoring table.

[FIG. 13] An example of a performance monitoring table containing prediction values for after the migration operation.

### DESCRIPTION OF THE PREFERRED EMBODIMENTS

The embodiments of the present invention will be described in detail with references to the figures.

FIG. 2 shows the architecture of a network system including a data center (240) according to an embodiment of the present invention and client PCs accessing the data center (240). In this figure, the data center (240) consists of the elements shown below the LAN/WAN (local area network/wide area network 204). Client PCs (201-203) access the data center (240) via the LAN/WAN (204) to receive various services provided by providers A-C (233-235). Servers (205-207) and data storage systems (209) are connected to a storage area network (SAN 208).

FIG. 3 shows the detail of the internal architecture of the storage system (209). Different types of storage media are stored in the storage system (209). In this figure, types A, B and C are exemplary shown for easy understanding. The number of storage media types does not have to be three, and can be varied).

The storage unit includes a service processor SVP (325), that monitors the performance of these elements and controls the condition settings and execution of various storage operations. The SVP (325) is connected to a performance monitoring PC (323).

The performance maintenance described above is provided in the present invention by using a performance monitoring part (324) in the form of a program running on the SVP (325). More specifically, performance maintenance is carried out by collecting parameters that quantitatively indicate performances of individual elements. These collected parameters are compared with performance requirement parameters (326). The performance requirement parameters (326) are set in the SVP (325) of the data storage system. Depending on the results of the comparison between the actual storage performance variables and performance requiring parameters, performance maintenance operations will be started. This will be described in detail later along with the description of service level agreements. In addition to simple comparisons of numerical values, the comparisons with performance requirement parameters can include comparisons of flexible conditions such as comparisons with functions.

Since the SVP (325) is set inside the data storage system, it can be used only by the administrator. Thus, if functions similar to those provided by the performance monitoring part (324) are to be used from outside the data storage system, this can be done bey using the performance monitoring PC. In other words, in the implementation of the present invention, the location of the performance storage part does not matter. The present invention can be implemented as long as data storage system performance can be monitored, comparisons between the actual storage performance variables and performance requiring parameters can be made, and the data storage system can be controlled based on the comparison results.

The following is a more specific description. First, examples of parameters monitored by the performance monitoring part (324) will be described. Examples of parameters include: disk free space rate; disk busy rate; I/O accessibility; data transfer volume; data transfer speed; and the amount of cache-resident data. The disk free space mate is defined as (overall contracted disk space) divided by (free disk space). The disk busy rate is defined as the time during which storage media (the physical disk drives) are being accessed per unit time. I/O accessibility is defined as the number of read/write operations completed per unit time. Data transfer volume is defined as the data size that can be transferred in one I/O operation. Data transfer speed is the amount of data that can be transferred per unit time. And the amount of cache-resident data is the data volume being staged to the cache memory.

While using the data storage system, storage performance can fall if the number of accesses to a specific device suddenly increases or increases during specific times of the day. Reduced storage performance can be detected by checking if the parameter values described above exceed threshold values. If this happens, the concentrated load against some specific device is distributed so that a required storage performance can be maintained.

When storage performance falls due to localized concentration of accesses, the accesses must be distributed to maintain storage performance.

The present invention provides a method for distributing storage locations for data in a data storage system.

In the network system shown in FIG. 2, the data center (240) equipped with the data storage system (209) and the servers (205-207) is contracted to provide storage capacity and specific servers to the providers (233-235). The providers (233-235) use the storage capacities allowed by their respective contracts and provides various services to end-users' client PCs (201-203) via the LAN/WAN. Thus, this network system is set up through contracts between three pasties (data center -provider contracts and provider-end user contracts).

FIG. 2 also schematically shows the schematic relationship between the data center (240) equipped with the data storage system and the servers, the providers (233-235), and the client PCs (201-203). The end user uses a client PC (201-203) to access the data center (240) via a network. The data center (240) stores data of the providers (233-235) contracted by the end user. The providers (233-235) entrust the management of the data to the data center (240) and the data center (240) charges the fees to the providers (233-235). The client using the services provided by the providers pays the charge for such services.

As described above, the provider enters into a contract with the data center for system usage. The performance of the hardware provided by the data center (performance of the data storage system, servers, and the like) is directly related to the quality of the services provided to clients the provider. Thus, if a guarantee that storage performance will be maintained can be included in the contract between the data center and the provider the provider will be able to provide services with reliable quality to the end users. The present invention makes this type of reliability in service quality possible.

A concept referred to as the service level agreement (SLA) is introduced in the data center operations that use this network system. The SLA is used for quantifying storage performance that can be provided by the data storage system (209) and providing transparency for the services that can be provided.

Service level agreements (SLA) will be described briefly. In service contracts, it would be desirable to quantify the services provided and to clearly identify service quality by indicating upper bounds or lower bounds. For the party receiving services, this has the advantage of allowing easy comparisons with services from other firms. Also, services that are appropriate to the party's needs can be received at an appropriate price. For the provider of services, the advantage is that, by indicating the upper bounds and lower bounds that can be provided for services and by clarifying the scope of responsibilities of the service provider, clients receiving services are not likely to hold unrealistic expectations and unnecessary conflicts can be avoided when problems occur.

Of the agreements between the data center, the provider, and the end user, the service level agreement (SLA) in the present invention relates to the agreements between the data center and the providers (233-235). The service level agreement is determined by the multiple elements to be monitored by the performance monitoring part (324) described above and the storage device contract capacity (disk capacity) desired by the provider.

The following is a description of the flow of operations performed when the data center and a provider enter into a service level agreement using these parameters.

First, the flow of operations performed to determine the contents of the guarantee (target performance) given by the data center to the provider will be described using FIG. 4. (Flowchart for setting service level agreement: step 401-step 407).

In FIG. 4, the provider selects one of the storage guarantee categories for which the data center wants a guarantee, e.g., disk busy rate by RAID group (rate of time during which storage medium is active due to an access operation), proportion of free storage space (free space/contracted space) (step 402). The operations performed for entering a setting in the selected category will be described later using FIG. 5.

Next, the provider sets guarantee contents and values (required performance levels) for the selected guarantee categories (step 403). For example, if the guarantee category selected at step 402 is the drive busy rate, a value is set for the disk busy rate, e.g., “keep average disk busy rate at 60% or less per RAID group” or “keep average disk busy rate at 80% or less per RAID group.” If the guarantee category selected at step 402 is the available storage capacity rate, a value is set up for that category, e.g., “increase capacity so that there is always 20% available storage capacity (In other words, disk space must be added if the available capacity drops below 20% of the contracted capacity. If the capacity contracted by the provider is 50 gigabytes, there must be 10 gigabytes of unused space at any time)”. In these examples, “60%” and “80%” are the target performance values (in other words, agreed service levels).

Once the guarantee categories and guarantee contents have been determined, the charge for data storage associated with this information is presented to the provider. The provider decides whether or not to accept these charges (step 404). Since the guarantee values contained in the guarantee contents affect the usage of hardware resources needed by the data center to provide the guarantee contents, the fees indicated to the provider will vary accordingly. Thus, the provider is able to confirm the variations in the charge. Also, if the charge is not reasonable for the provider, the provider can reject the charge and go back to entering guarantee content information. This makes budget management easier for the provider. Step 403 and step 404 will be described later using FIG. 6.

Next, all the guarantee categories are checked to see if guarantee contents have been entered (step 405). Once this is done, the data center outputs the contracted categories again so that the provider can confirm guarantee categories, agreed service level (performance values), the charge, and the like (step 406). It would be desirable to let the provider confirm the total charge for all category contents as well.

FIG. 5 is a drawing for the purpose of describing step 402 from FIG. 4 in detail. As shown in FIG. 5, guarantee contents can, for example, be displayed as a list on a PC screen. The provider, i.e., the data center's client, makes selections from this screen. This allows the provider to easily select guarantee contents. If the provider has thready selected the needed categories, it would be desirable, for example, to have a control flow (not shown in the figure) from step 402 to step 406 in FIG. 4.

FIG. 6 shows an exemplified method for implementing step 403 and step 404 from FIG. 4. In FIG. 6, recommended threshold values and their fees are displayed for different provider operations. For example, provider operations can be divided into type A (primarily on-line operations with relatively high restrictions on delay time), type B (primarily batch processing with few delay time restrictions), type C (operations involving large amounts of data), and the like. Suggested drive busy rates corresponding to these types would be displayed as examples. Thus, the provider can choose which type its end-user services belong to and can select the type. The values shown are recommended values, so the provider can modify these values later based on storage performance statistics data presented by the data center. The method indicated in FIG. 6 is just one example, and it would also be possible to have step 403 and step 404 provide a system where values simply indicating guarantee levels are entered directly and corresponding fees are confirmed.

As described above, with references to FIG. 4 through FIG. 6, the operations performed for determining service guarantee categories and contents are practiced. The selected service guarantee categories and contents are stored in storage means, e.g., a memory, of the SVP via input means of the SVP. This information is compared with actual storage performance variables collected by the monitoring part. Storage is controlled based on these results. Regarding the entry of service categories and content performance target values into the SVP, the need to use input means of the SVP can be eliminated by inputting the information via a communication network from a personal computer supporting the steps in FIG. 4.

FIG. 4 shows the flow of operations performed for entering a service level agreement. FIG. 5 and FIG. 6 show screens used by the provider to select service levels. The category selection screen shown in FIG. 5 corresponds to step 402 from FIG. 4 and the threshold value settings screen corresponds to step 403 from FIG. 4.

The service level agreement settings are made with the following steps. The provider wanting a contract with the data center selects one of the categories from the category selection screen shown in FIG. 5 and clicks the corresponding check box (step 402). A threshold setting screen (FIG. 6) for the selected category is displayed, and the provider selects the most suitable option based on the scale of operations, types of data, budget, and the like. The threshold is set, by checking one of the checkboxes on, as such in FIG. 6 (step 403).

The following is a description of a method for operating the data center in order to actually fulfill the service level agreement made by the process described above.

FIG. 7 shows a sample busy rate monitoring screen. Busy rates are guaranteed for individual RAID groups (described later). The busy rate monitoring screen can be accessed from the SVP (325) or the performance monitoring PC (323). The usage status for individual volumes is indicated numerically. The busy rate monitoring screen includes: a logical volume number (701); an average busy rate (702) for the logical volume; a maximum busy rate (703) for the logical volume; a number identifying a RAID group, which is formed from multiple physical disk drives storing sections of the logical volume; an average and maximum busy rate for the entire RAID group (706); and information (704, 705) indicating the usage status of the RAID group. Specific definitions will be described later using FIG. 11.

The information (704, 705) indicating RAID group usage status will be described. A RAID group is formed as a set of multiple physical disk drives storing multiple logical volumes that have been split, including the volume in question. FIG. 1 shows a sample RAID group formed from three data disks. (The number of disks does not need to be three and can be varied).) In this figure, RAID group A is formed from three physical disk drives D1-D3 storing four logical volumes V0-V3. In this example, the new RAID group A′ is formed from the logical volumes V1-V3 without logical volume V0.

The information (704, 705) indicating RAID group usage status for the logical volume V0 is information indicating the overall busy rates for the newly formed RAID group A MID group A without the logical volume V0). The numeric values indicate the average (704) and the maximum (705) busy rates. In other words, when the logical volume V0 is moved to some other RAID group, the values indicate the average drive busy rate for the remaining logical volumes.

After the service level agreement has been set, a performance requirement parameter, like threshold values are set based on the service level agreement, and the relationship between actual storage busy rates (702-705) and the threshold values are monitored continuously through the monitoring screen shown in FIG. 7. Data is migrated automatically or by an administrator if a numerical value indicating the actual storage performance variable (in this case, the busy rate) is about to exceed an “average XX%” value or the like guaranteed by the service level agreement, i.e., the value exceeds the performance requirement parameter, such as the threshold value. (The “average XX%” guaranteed by the service level agreement is generally set in the performance monitoring part (324) as the threshold value, and the average value is kept to XX% or less by moving data when a parameter exceeds the threshold value.)

The following is a detailed description of a method for guaranteeing a drive busy rate.

First, using FIG. 1, the relationship between logical volumes (logical devices), which the server uses as storage access units, and physical drives, in which data is recorded, will be described. Taking a data storage system with a RAID (Redundant Array of Inexpensive Disks) Level 5 architecture as an example, multiple logical volumes are assigned to multiple physical drives (RAID group), as shown in FIG. 1. The logical volumes are assigned so that each logical volumes is distributed across multiple physical drives. This data storage system is set up with multiple RAID groups, each group being formed from multiple physical drives. Logical volumes, which serve as the management units when recording data from a server, are assigned to these RAID groups. RAIDs and RAID levels are described in D. Patterson, G. Gibson, and R. Katz, “Case for Redundant Arrays of Inexpensive Disks (RAMM), Report No. UCB/CSD 87/391 (Berkeley: University of California, December 1987). In FIG. 1, the RAID group is formed from three physical drives D, but any number of drives can be used.

With multiple logical volumes assigned to multiple physical drives as described above, concentrated server accesses to a specific logical volume will negatively affect other logical volumes associated with the RAID group to which the specific volume is assigned. Also, if there is an overall increase in accesses to the multiple logical volumes belonging to a RAID group, the busy rate to the physical drives belonging to the RAID group will increase, and the access delay time for the logical volumes will quickly increase. The busy rate for the RAID group can be kept at or below a specific value by monitoring accesses to these logical volumes, collecting statistical data relating to access status to drives, and moving logical volumes to other RAID groups with lower busy rates.

If the agreement between the provider and the data center involves keeping the busy rate of the physical Hives of a particular RAID group at or below a fixed value, the data center monitors the accesses status of such RAID group in the data storage system and moves the logical volume in the RAID group to another RAID group if necessary, thus maintaining a performance value for the provider.

FIG. 11 shows an example of a performance management table used to manage RAID group 1 performance. Performance management tables are set in association with individual RAID groups in the data storage system and are managed by the performance management part in the SVP. In this table, busy rates are indicated in terms of access time per unit time for each logical volume (V0, V1, V2, . . . ) in each drive (D1, D2, D3) belonging to the RAID group 1. For example, for drive D1 in FIG. D1, the busy rate for the logical volume V0 is 15% (15 seconds out of the unit time of 100 seconds is spent accessing the logical volume V0 of the drive D1), the busy rate for the logical volume V1 is 30% (30 seconds out of the unit time of 100 seconds is spent accessing the logical volume V1 of the drive D1), and the busy rate for the logical volume V2 is 10% (10 seconds out of the unit time of 100 seconds is spent accessing the logical volume V2 of the drive D1). Thus, the busy rate for drive D1 (which is the sum of the logical volumes per unit time) is 55%. Similarly, the busy rate for drive D2 is: 10% for the logical volume V0; 20% for the logical volume V1; and 10% for the logical volume V2. The busy rate for the drive D2 is 40%. Similarly, the busy rates for the drive D3 are: 7% for the logical volume V0; 35% for the logical volume V1 ; and 15% for the logical volume V2. The busy rate for the drive D2 [?D3?] is 57%. Thus, the average busy rate for the three drives is 50.7%. Also, the maximum busy rate for a drive in the RAID group is 57% (drive D3).

FIG. 12 shows an example in which a logical volume V3 and a logical volume V4 are assigned to RAID group 2. In this example, drive D1 has a busy rate of 15%, drive D2 has a busy rate of 15%, and drive D3 has a busy rate of 10%. The average busy rate of the drives belonging to the RAID group is 13.3%.

These drive busy rates can be determined by having the DKA of the disk control device DKC measure drive access times as the span between drive access request through the response from the drive, and reporting these times to the performance monitoring part. However, if the disk drives themselves can differentiate accesses from different logical volumes, the disk drives themselves can measure these access times and report these times to the performance monitoring part. The drive busy rate measurements need to be performed according to definitions within the system so that there are no contradictions. Thus, definitions can be set up freely as long as the drive usage status can be indicated according to objective and fixed conditions.

In the following example, an average drive busy rate of 60% or less is guaranteed by the data center for the provider. If the average drive busy rate is to be 60% or less for a RAID group, operations must be initiated at a lower busy rate (threshold value) since a delay generally accompanies an operation performed by the system. In this notice, if the guaranteed busy rate in the agreement is 60% or less, operations are begun at a busy rate (threshold value) of 50% to guarantee this required performance.

In FIG. 11 described previously, the average busy rate of the drives in the RAID group exceeds 50%, making it possible for the average busy rate of the drives in the RAID group 1 to exceed 60%. The performance monitoring part of the SVP therefore migrates one of the logical volumes from the RAID group 1 to another RAID group, thus initiating operations with an average drive busy rate in the RAID group that is 50% or lower.

In this case, two more issues must be dealt with to begin operations. One is determining which logical volume is to be migrated from the RAID group 1 to another RAID group. The other is the RAID group to which the volume is to be migrated.

In migrating a logical volume from the RAID group 1, the logical volume must be selected so that the source group, i.e., the RAID group 1, will have an average busy rate of 50% or less. FIG. 11 also shows the average drive busy rates in the RAID group 1 when a volume is migrated to some other RAID group. In this example, if the logical volume V0 is migrated to some other RAID group, the average drive busy rate from the remaining volumes will be 40% (corresponds to the change from RAID group A to A′ in FIG. 1). Migrating the logical volume V1 to some other RAID group results in an average drive busy rate of 22.3% for the remaining volumes. Migrating the logical volume V2 to some other RAID group results in an average drive busy rate of 39.0% for the remaining volumes. Thus, for any of these the rate will be at or below 50%, and any of these options can be chosen. In the description of this embodiment, the logical volume V2 is migrated, providing the lowest average busy rate for the RAID group 1. In addition to reducing the average busy rate to 50% or lower, the logical volume to migrate can also be selected on the basis of the frequency of accesses since migrating a logical volume experiencing fewer accesses will provide less of an impact on accesses. For example, in the case of FIG. 11, the logical volume V0 can be selected since the average busy rate is lowest. Alternatively, since migrating logical volumes that contain less actual data will take less time, it would be possible to keep track of data sizes in individual logical volumes (not illustrated in the figure) and to select the logical volume with the least data.

Next, the destination for the logical volume must be determined. In determining a destination, not violating the agreement with the provider requires that the current average drive busy rate stays at or below 50% and the destination RAID group for the selected logical volume must have an average drive busy rate that stays at or below 50% (the threshold value) even after the selected logical volume has been moved there. FIG. 13 shows a prediction table for when the logical volume V1 is moved from the RAID group 1 to the RAID group 2. The average drive busy rate of the RAID group 2 is currently 13.3%, so it the group can accept a logical volume from another RAID group. The table shows the expected drive busy rates for a new RAID group, formed after receiving logical volume V1 (bottom of FIG. 13). As shown in the table, the predicted average drive busy rate after accepting the new volume is 41.7%, which is below the threshold value. Thus, it is determined that the volume can be accepted, and the formal decision is then made to move the logical volume V1 from the RAID group 1 to the RAID group 2. To guarantee performance in this manner, it is necessary to guarantee the busy rate of the source RAID group as well as calculate, predict, and guarantee the busy rate of the destination RAID group before moving the logical volume. If the expected busy rate exceeds 50%, a different RAID group table is searched and the operations described above are repeated.

As described above, the data center can provide the guaranteed service level for the provider in both the logical volume source and destination RAID groups.

In the example described above, a 50% threshold value is used for migrating logical volumes and a 50% threshold value is used for receiving logical volumes. However, using the same value for both the migrating condition and the receiving condition may result in logical volumes being migrated repeatedly. Thus, it would be desirable to set the threshold for the migrating condition lower than the threshold for the receiving condition.

Also, the average busy rates described above are used here to indicate the busy rates of drives in RAID group. However, the drive with the highest busy rate affects responses for all accesses to RAID group, it would also be possible to set the guarantee between the provider and the data center based on a guarantee value and corresponding threshold value for the drive with the highest busy rate.

Furthermore, the performance of the drives in the RAID group 1 (source) and the performance of the drives in the RAID group 2 (destination) are presented as being identical in the description of FIG. 13. However, the performance of the drives in the destination RAID group 2 may be superior to the performance of the source drives. For example, if read/write speeds to the drive are higher, the usage time for the drives will be shorter. In such cases, the RAID group 2 busy rate after receiving the logical volume can be calculated by multiplying a coefficient reflecting performance differences to the busy rates of individual drives of the logical volume V1 in the RAID group 1 to the busy rates of individual drives in the RAID group 2. If the destination drives have inferior performance, inverse coefficients can be used.

In the operation described above, the performance management part (software) can be operated with a scheduler so that checks are performed periodically and operations are performed automatically if a threshold value is exceeded. However, it would also be possible to have the administrator look up performance status tables and expectation tables to determine if logical modules should be migrated. If a migration is determined to be necessary, instructions for migrating the logical module are sent to the data storage system.

In the example described above, the RAID groups have the same guarantee value. However, it would also be possible to have categories such as type A, type B, and type C as shown in FIG. 3, with a different value for each type based on performance, e.g., type A has a guarantee value of 40%; type B has a guarantee value of 60%; type C has a guarantee value of 80%. In this case, logical volumes would be migrated between RAID groups belonging to the same type.

This concludes the description of the procedure by which performance guarantees are set through a service level agreement and of an example of how performance is guaranteed using busy rates of physical disk drives. Next, the procedure by which a service level agreement is implemented in actual operations will be described with reference to FIG. 8 using an example in which performance is guaranteed by moving data.

At the start of operations or at appropriate times, threshold values for parameters are set up manually for the performance monitoring part 324 on the basis of performance requirement parameters guaranteed by the service level agreement (step 802). The performance monitoring part detects when actual storage performance variables of the device being monitored exceed or drop below threshold values (step 803, step 804). Threshold values are defined with maximum values (MAX) and minimum values (MIN). The variable exceeding the maximum value indicates that it will be difficult to guarantee performance. The variable about to drop below the minimum value indicates that there is too much extra availability in resources so that the user is operating beyond specifications (this will be described later). If the variable exceeds the threshold value in the form of an average value XX%, a determination is made as to whether the problem can be solved by migrating data (step 805). As described with reference to FIG. 11 through FIG. 14, this determination is made by predicting busy rates of the physical drives belonging to the source and destination RAID groups. If there exists a destination storage medium that allows storage performance to be maintained, data will be migrated (step 807). This data migrating operation can be performed manually based on a decision by an administrator, using server software, or using a micro program in the data storage system. If no destination storage medium is available because the maximum performance available from the data storage system is already being provided, the SVP 325 or the performance monitoring PC 323 indicates this by displaying a message to the administrator, and notifies the provider if necessary. The specific operations for migrating data can be provided by using the internal architecture, software, and the like of the data storage system described in Japanese patent, publication number 9-274544.

FIG. 9 shows the flow of operations for generating reports to be submitted to the provider. This report contains information about the operation status of the data storage system and is sent periodically to the provider. The operation status of the data storage system can be determined through various elements being monitored by the performance monitoring part 324. The performance monitoring part collects actual storage performance variables (step 902) and determines whether the performance guaranteed by the service level agreement (e.g., average XX% or lower) is achieved or not (step 903). If the service level agreement (SLA) is met, reports are generated and sent to the provider periodically (step 904, step 906). If the service level agreement is not met, a penalty report is generated and the provider is notified that a discount will be applied (step 905, step 906).

This concludes the description of how, when the busy rate is about to exceed the performance requirement parameters which indicates the agreed service level in the contract due to accesses concentrated in a localized manner (to a specific physical drive), the logical volumes belonging to that physical drive are migrated so that the accesses to each physical drives are equalized. An alternative to the method described above for deconcentrating localized load concentration in a data storage system is to temporarily create a mirror disk of the data for which load is concentrated (in the example shown in FIG. 7, the data having a high busy rate) so that accesses can be deconcentrated, thus maintaining the performance guarantee values. This method must take into account the fact that, on average, half of the accesses to the mirrored original drive will remain. In other words, post-mirroring busy rates must be predicted by taking into account the fact that accesses corresponding to half the busy rate of the logical volume will continue to be directed at the current physical drive.

In the practice as described above, in the load deconcentration method involving the migrating of data (to maintain performance guarantee values) as described above, the data (a logical volume) will be migrated to a physical drive in a different RAID group within the same data storage system. However, as shown in FIG. 10, the data can also be migrated to a different data storage system connected to the same storage area network (SAN). In such case, it would also be possible to have devices categorized according to the performance it can achieve, e.g., “a device equipped with high-speed, low-capacity storage devices” or “a device equipped with low-speed, high-capacity storage devices”. When determining a destination (in another device), the average busy rates and the like for the multiple physical drives in the RAID group in the different data storage system are obtained and used to predict busy rates at the destination for once the logical volume has been migrated. These average busy rates and the like of the multiple physical drives in the other device can be obtained by periodically exchanging messages over the SAN or issuing queries when necessary.

The service level agreement made between the provider and the data center is reviewed when necessary. If the service level that was initially set results in surplus or deficient performance, the service level settings are changed and the agreement is updated. For example, in FIG. 6, the agreement may include “X>YY>ZZ” and a physical drive is contracted at YY%, the average type B busy rate. If, in this case, the average busy rate is below ZZ%, there is surplus performance. As a result, the service level is set to type C average busy rate of ZZ% and the agreement is updated. By doing this, the data center can gain free space, so as to provide them to a new potential customer, and the provider can cut cost. And this is beneficial to both of the parties.

As another example of a service level agreement, there is a type of agreement that the service level will be changed temporary. For example, a provider may want to propose a newspaper advertisement concerning some particular contents stored in a particular physical disk drive. In such case, if such contents are stored in a high-capacity, low-speed storage device, they have to be moved to a low-capacity, high-speed storage device, as a flood of data access is expected, because of the advertisement. In this case, additional charge for using high-speed storage device will be paid. As the increase of data access to such data will expected to be a temporal one, the provider may want the concerning data to be stored in the low-capacity, high-speed storage device for some short period, and then moved back to the high-capacity, low-speed storage device to cut expense. The data center will be notified in advance, that the provider wants to modify the service level agreement for -the particular data Then, during this period specified by the provider, data center will modify the performance requirement parameter for the specified data.

In the description above, busy rates of physical drives in RAID groups are guaranteed. However, services based on service level agreements can be provided by meeting other performance guarantee categories, e.g., the rate of free diskspace. I/O accessibility, data transfer volume, and data transfer speeds.

For example, a service level agreement may involve allocating 20% free disk space at any time, relative to the total contracted capacity. In this case, the data center leasing the data storage system to the provider would compare the disk capacity contracted by the provider with the disk capacity that is actually being used. If the free space drop under 20%, the provider would allocate new space so that 20% is always available as free space, thus maintaining the service level.

In the embodiment described above and in FIG. 3, the server and the data storage system are connected by a storage area network However, the connection between the server and the data storage system is not restricted to a network connection.

### Advantages of the Invention

As described above, the present invention allows the data storage locations to be optimized according to the operational status of the data storage system and allows loads to be equalized when there is a localized overload. As a result, data storage system performance can be kept at a fixed level guaranteed by an agreement even if there is a sudden increase in traffic.

What is claimed is:

1. A data storage system comprising:
an input part which receives performance requirement parameters concerning storage performance for each of a plurality of data storage areas within the data storage system;
a first comparing part which compares the performance requirement parameters with actual storage performance variables;
a first detection part which detects at least one data storage area where the actual storage performance variables do not satisfy the performance requirement parameters; and
a migration part which migrates data stored in the data storage area detected by the first detection part to another storage area.

2. The system of claim 1, further comprising:
a calculation part which calculates an average of the actual storage performance variables per unit time;
a second comparing part which compares the average and the performance requirement parameters; and
a second detection part which detects a data storage area where the average per unit time does not satisfy the performance requirement parameters.

3. The system of claim 1, wherein the storage performance is determined by at least one of the following:
I/O accessibility;
data transfer volume;
disk free space rate;
disk busy rate;
data transfer speed; and
an amount of cache resident data.

4. The system of claim 2, wherein the storage performance is determined by at least one of the following:
I/O accessibility;
data transfer volume;
disk free space rate;
disk busy rate;
data transfer speed; and
an amount of cache resident data.

5. The system of claim 1, wherein the migration part performs the following steps:
staging data into cache;
creating a mirror disk;
varying data redundancy; and
transferring data from one physical volume to another physical volume.

6. A method for providing data storage service, the method comprising:
making a service level agreement concerning a requirement for storage performance;
setting performance requirement parameters in accordance with the service level agreement;
monitoring an actual storage performance variable; and
reallocating data stored in a data storage area where the actual storage performance variable does not satisfy the performance requirement parameters.

7. The method of claim 6 further comprising the steps of:
calculating an average of the actual storage performance variables per unit time; and
refunding a charge paid by a contractor who used the data storage area where the average did not satisfy the performance requirement parameters, the charge being paid in accordance with the service level agreement.

8. The method of claim 7 further comprising the step of reporting the actual storage performance variables to the contractor.

9. A method for providing data storage services comprising:
making a service level agreement including requirements for storage performance;
setting performance requirement parameters in accordance with the service level agreement;
monitoring actual storage performance variables; and
reallocating the data stored in a data storage area when the actual storage performance variables do not satisfy the performance requirement parameters.

10. The method of claim 9, wherein the performance requirement parameters are associated with each of the data storage areas, and a charge for data storage is determined in accordance with the performance requirement parameters.

11. The method of claim 10 further comprising:
calculating an average of the actual storage performance variables per unit time;
identifying the data storage area where the actual storage performance variables does not satisfy the performance requirement parameters; and
outputting information about the designated data storage area to enable refunding a charge of data storage.

12. The method of claim 6, wherein the data reallocation comprises:
staging the data into cache;
creating a mirror disk;
varying data redundancy; and
transferring data from one physical volume to another physical volume.

13. The method of claim 10, wherein the step of reallocating the data comprises:
staging data into a cache;
creating a mirror disk;
varying data redundancy; and
transferring data from one physical volume to another physical volume.

14. A method for allocating data storage area within a system comprising of storage device and storage controller, the method comprising the steps of:
setting performance requirement parameters for the storage controller, the performance requirement parameters associated with each of a plurality of data storage areas;
monitoring access frequency for the data storage areas; and
reallocating data stored in a data storage area where the access frequency does not satisfy the performance requirement parameters.

15. The method of claim 14 further comprising the steps of:
charging for the data storage, the charge being determined in accordance with the performance requirement parameters; and
reducing the charge if the performance requirement parameters are not satisfied, the reduction being made in accordance with a length of time while the performance requirement parameters are not satisfied.

16. The method of claim 14 wherein the storage performance is determined by at least one of the following:
I/O accessibility;
data transfer volume;
disk free space rate;
disk busy rate;
data transfer speed; and
an amount of cache resident data.

17. The method of claim 16, wherein the data reallocation comprises:
staging the data into cache;
creating a mirror disk;
varying data redundancy; and
transferring data from one physical volume to another physical volume.

18. A method of managing a data storage system accessed via a network, wherein the system is comprised of a network connected server, and a data storage system connected to the server, the method comprising:
receiving at least one performance requirement parameter indicating system performance desired by a contractor, wherein each performance requirement parameter received to the data storage system is associated with a particular data storage area;
checking actual storage performance by referring to the performance requirement parameter; and
migrating data stored in the data storage area if the actual storage performance does not satisfy the performance requirement parameter.
